(19) United States
(12) Patent Application Publication
(10) Pub. No.: US 2014/0105246 A1
(43) Pub. Date: Apr. 17, 2014

(54) Temperature Controlled Structured ASIC Manufactured on a 28 NM CMOS Process Lithographic Node

(71) Applicant: eASIC Corporation, (US)

(72) Inventors: Alexander Andreev, San Jose, CA (US); Massimo Verita, Pleasanton, CA (US)

(73) Assignee: eASIC CORPORATION, Santa Clara, CA (US)

(21) Appl. No.: 13/649,563

(22) Filed: Oct. 11, 2012

(51) Int. Cl. G01K 7/01

(52) U.S. Cl. CPC G01K 7/01
USPC 374/178

(57) ABSTRACT

A temperature control for a Structured ASIC chip, manufactured using a CMOS process is shown. A circuit employing temperature feedback using a microprocessor and active heating elements, that in a preferred embodiment uses decoupling cell capacitors, is employed to actively heat a die when the temperature of the die drops below a predetermined minimum temperature, in order to achieve timing closure in the chip.

### CROSS-REFERENCE TO RELATED APPLICATIONS

The present application is related to: U.S. application Ser. No. ______, Attn. Docket No. EAS 12-1-2 for “VIA-CONFIGURABLE HIGH-PERFORMANCE LOGIC BLOCK INVOLVING TRANSISTOR CHAINS” by Alexander Andreev, Sergey Gribok, Ranko Scepanovic, Phey-Chuin TAN, Chee-Wei KUNG, filed the same day as the present invention, ______ 2012; U.S. application Ser. No. ______, Attn. Docket No. EAS 12-2-2 for “ARCHITECTURAL FLOORPLAN FOR A STRUCTURED ASIC MANUFACTURED ON A 28 NM CMOS PROCESS LITHOGRAPHIC NODE OR SMALLER” by Alexander Andreev, Ranko Scepanovic, Ivan Pavisic, Alexander Yahontov, Mikhail Udovikhin, Igor Vikhliantsev, Chong-Teik LIM, Seow-Sung LEE, Chee-Wei KUNG, filed the same day as the present invention, ______ 2012; US. application Ser. No. ______, Attn. Docket No. EAS 12-3-2 for “CLOCK NETWORK FISHBONE ARCHITECTURE FOR A STRUCTURED ASIC MANUFACTURED ON A 28 NM CMOS PROCESS LITHOGRAPHIC NODE” by Alexander Andreev, Andrey Nikishin, Sergey Gribok, Phey-Chuin TAN, Choon-Hun CHOO, filed the same day as the present invention, ______ 2012; U.S. application Ser. No. ______, Attn. Docket No. EAS 12-4-2 for MICROCONTROLLER CONTROLLED OR DIRECT MODE CONTROLLED NETWORK-FABRIC ON A STRUCTURED ASIC” by Alexander Andreev, Andrey Nikitin, Marian Serbian, Massimo Verita, filed the same day as the present invention, ______ 2012; Attn. Docket No. EAS 12-6-2 for “DIGITALLY CONTROLLED DELAY LINE FOR A STRUCTURED ASIC HAVING A VIA CONFIGURABLE FABRIC FOR HIGH-SPEED INTERFACE” by Alexander Andreev, Sergey Gribok, Marian Serbian, Massimo Verita, Kee-Wei SIM, Kok-Hin LEW, filed the same day as the present invention, ______ 2012; and all assigned to the same Assignee as the present invention, all of which are specifically incorporated herein by reference.

### BACKGROUND OF THE INVENTION

1. Field of Invention

The present invention relates generally to the field of Structured ASICs. Embodiments of the present invention relate to temperature control for a Structured ASIC.

2. Description of Related Art

The present invention relates generally to temperature control for a Structured ASIC.

A Structured ASIC is an ASIC (Application-Specific Integrated Circuit) having some pre-made elements that are manufactured once in a first manufacturing process and kept in inventory, then the elements are interconnected later, or customized by a customer, in a second manufacturing process by masks (mask-programmable) rather than making a circuit all at once as in a traditional ASIC. In a Structured ASIC the customization occurs by configuring one or more via layers between metal layers in the ASIC.

In an integrated circuit a die is a small block of semiconducting material upon which a circuit is fabricated. Integrated circuits are produced in large batches on a single wafer of electronic-grade silicon or other semiconductor (such as GaAs) through processes such as photolithography. The wafer is cut (“diced”) into many pieces, each containing one copy of the circuit. Each of these pieces is called a die, or in plural, dices or dies.

A configurable logic block (CLB) may be an element of field-programmable gate array (FPGA), structured ASIC devices, and/or other devices. CLBs may be configured, for example, to implement different random logic (from combinational logic, such as NANDs, NORs, or inverters, and/or sequential logic, such as flip-flops or latches).

Broadly defined, structured application-specific integrated circuits (ASICs) may attempt to reduce the effort, expense and risk of producing ASICs by standardizing portions of the physical implementation across multiple products. By amortizing the expensive mask layers of the device across a large set of different designs, the non-recurring engineering (NRE) for a customized ASIC seen by a particular customer, which are one-time costs that do not depend on the number of units sold, can be significantly reduced. There may be additional benefits to the standardization of some portion of mask set, which may include improved yield through higher regularity and/or reduced manufacturing time from tape-out to packaged chip.

ASICs can be broken down further into a full-custom ASIC, a Standard Cell-based ASIC (standard-cell), and a gate array ASIC. At the opposite end of an ASIC is a field-programmable gate array (FPGA), an integrated circuit designed to be configured by the customer or designer after manufacturing in the field using software commands rather than at a foundry or IC fab. Other non-ASICs include simple and complex PLDs (Programmable Logic Devices), and off-the-shelf small and medium scale IC components (SSI/MSI).

A full-custom ASIC customizes every layer in an ASIC device, which can have 10 to 15 layers, requiring in a lithography process 10 to 15 masks. Since the customized design of the ASIC occurs at the transistor level, and modern ASICs have tens if not hundreds of millions of transistors, a full-custom ASIC is typically economically feasible only for applications that required millions of units. An example of such an application is the cell phone digital modem or a flat panel television video processing device.

In a standard cell ASIC, circuits are constructed from predefined logic components known as cells. Designers work at the gate level, not the finer transistor level, simplifying the process, and instead of 10-15 layers only 3-5 layers may exist. The fab manufacturing the device provides a library of basic building blocks that can be used in the cells, such as basic logic gates, combinational components (and-or-inverter, multiplexer, 1-bit full adder), and basic memory, such as D-type latch and flip-flop. A library of other function blocks such as adder, barrel shifter and random access memory (RAM) may also exist. While the layout of each cell in a standard cell is predetermined, the circuit itself has to be uniquely constructed by connecting all layers to one another and the cells within each layer in a custom manner, which takes time and effort.

A register is a standard component in an ASIC, and is a group of flip-flops that stores a bit pattern. Registers can hold information from components or hold state between iterations of a clock so that it can be accessed by other components, to allow I/O synchronization, handshaking data between clock domains, pipelining, and the like.

In a gate-array ASIC, the level of abstraction is one level higher than a standard cell, in that each building block in a gate array is from an array of predefined cells, known as a base cell, which resembles a logic gate. Since location and type of cell is predetermined, gate-array ASICs can be manufactured in advance in greater quantities and inventoried for use later. A circuit is manufactured by customizing the interconnect between these cells, which is done at the metal layer via masks. In gate level ASICs, typically fewer metal layers have to be customized to specify the interconnect required to complete the circuit, which simplifies the manufacturing process.

A synchronous digital system has a clock distribution network that defines a reference point for moving data within the system. A clock distribution network distributes the clock signals from a common point to all the elements in the system that need it. Generally clock signals are loaded with a great fanout, travel over comparatively great distances, and operate at the higher speeds than other signals within the synchronous system. Clock waveforms must be particularly clean and sharp. In addition, long global interconnect lines become significantly more resistive as line dimensions are decreased, and is one of the primary reasons for the increasing significance of clock distribution on synchronous performance. The control of any differences and uncertainty in the arrival times of the clock signals can limit the maximum performance of the entire system and create race conditions in which an incorrect data signal may latch within a register. The clock distribution network often takes a significant portion of the power consumed by a chip; furthermore, significant power can be wasted in transitions within blocks, when their output is not needed. Power may be saved by clock gating, which involves adding logic gates to the clock distribution tree, so portions of the tree can be turned off when not needed.

A complex field programmable device is the most versatile non-ASIC, as the generic logic cells can be more sophisticated than ASIC cells, and the interconnect structure can be programmable in the field using software, rather than at a fab using for example photolithographic masks. A complex field programmable device can be re-programmed to a different circuit in hours, rather than only being programmable once at a fab like an ASIC. A complex field programmable device can be broadly divided into two categories, a Complex Programmable Logic Device (CPLD) and a Field Programmable Gate Array (FPGA). The logic cell of a CPLD is more complex than an FPGA, and has a D-type flip-flop and a programmable logic device semiconductor such as a PAL™ type programmable logic device semiconductor, with configurable product terms. The interconnect of a CPLD is more centralized, with fewer concentrated routing lines. A FPGA logic cell is smaller, with a D-type flip-flop and a small Look Up Table (LUT), a multi input and single output block that is widely used for logic mapping, or multiplexers for routing signals through the interconnect and logic cells. The interconnect structure in an FPGA tends to be more distributed and flexible than a CPLD, making it more ideal for more high capacity, complex devices. The FPGA design that defines a circuit is stored in RAM, so when the FPGA is powered off, the design for the circuit disappears. When the FPGA is powered back up, one must reload the circuit design from non-volatile memory.

A simple PLD, historically called a programmable logic device, is much more limited in application, as they do not have a general interconnect structure. Today these devices are relatively rare by themselves and are now used as internal components in an ASIC or CPLD. Likewise, off-the-shelf small and medium scale IC components (SSI/MSI) are rarely used anymore, as they are first generation devices such as the 7400 series transistor-transistor logic (TTL) manufactured by various companies used in the 1960s and 70s to build computers. These components are no longer supported by modern EDA (Electronic Design Automation) software and have very limited functionality.

A complex field programmable device can be thought of as a form of programmable logic fabric. One such programmable logic fabric is a SRAM programmable Look-Up Table (LUT) technology that forms the basis of Field Programmable Gate Arrays and Complex Programmable Logic Devices. The programmable fabric technology allows synthesis of a logic design described in a Hardware Description Language (HDL) to be synthesized on to the logic fabric in order to perform the required logic function. The logic fabric includes memory blocks, embedded multipliers, registers and Look-Up Table logic blocks. Interconnect between logic elements is also SRAM programmable. As the state of the SRAM is deleted when powered off, the function of the programmable logic fabric incorporating SRAM can be changed.

ASIC design flow as a whole is a complex endeavor that involves many tasks, as described further herein, such as: logic synthesis, Design-for-Test (DFT) insertion, Electric Rules Check (ERC) on gate-level netlist, floorplan, die size, I/O structure, design partition, macro placement, power distribution structure, clocks distribution structure, preliminary check, (e.g., IR drop voltage drop, Electrostatic Discharge (ESD)), placement and routing, parasitic extraction and reduction (parasitic devices), Standard Delay Format (SDF) timing data generated by EDA tools, various checks including but not limited to: static timing analysis, cross-talk analysis, IR drop analysis, and electron migration analysis.

At the first step in the ASIC design flow, the design entry step, the circuit is described, as in a design specification of what the circuit is to accomplish, including functionality goals, performance constraints such as power and speed, technology constraints like physical dimensions, and fabrication technology and design techniques specific to a given IC foundry. Further in the design entry step is a behavioral description that describes at a high-level the intended functional behavior of the circuit (such as to add two numbers for an adder), without reference to hardware. Next is a RTL (Register Transfer Language) structural description which references hardware, albeit at a high-level of abstraction using registers. RTL focuses on the flow of signals between registers, with all registers updated in a synchronous circuit at the same time in a given clock cycle, which further necessitates in the design flow that the clocks be synchronized and the circuits achieve timing constraints and timing closure. RTL description captures the change in design at each clock cycle. All the registers are updated at the same time in a clock cycle for a synchronous circuit. A synchronous circuit consists of two kinds of elements: registers and combinational logic. Registers have a clock, input data, output data and an enable signal port. Every clock cycle the input data is stored internally and the output data is updated to match the internal data. Registers, often implemented as flip-flops, synchronize the circuit's operation to the edges of the circuit clock signal, and have memory. Combinational logic performs all the logical functions in the circuit and it typically consists of logic gates. RTL is expressed usually in a Verilog or VHDL Hardware Description Language (HDL), which are industry standard language descriptions. A hardware description language (HDL) is a language used to describe a digital system, for example, a network switch, a memory or a flip-flop. By using a HDL one can describe any digital hardware.

A design flow progresses from logical design steps to more physical design steps. Throughout this flow timing is of critical importance and must be constantly reassessed so that timing closure is realized throughout the circuit, since timing between circuits could change at different stages of the flow. Furthermore, the circuit must be designed to be tested for faults. The insertion of test circuitry can be done at the logic synthesis step, where register transfer level (RTL), is turned into a design implementation in terms of logic gates such as a NAND gate. Thus logic synthesis is the process of generating a structural view from the RTL design output using an optimal number of primitive gate level components (NOT, NAND, NOR, and the like) that are not tied to a particular device technology (such as 32 nm features), nor do with any information on the components' propagation delay or size. In logical synthesis the circuit can be manipulated with Boolean algebra. Logical synthesis may be divided into two-level synthesis and multilevel synthesis. Because of the large number of fan-ins for the gates (the number of inputs to a gate), two-level synthesis employs special ASIC structures known as Programmable-Logic Arrays (PLA) and modified Programmable Array Logic (PAL)-based CPLD devices. Multilevel synthesis is more efficient and flexible, as it eliminates the stringent requirements for the number of gates and fan-ins in a design, and is preferred. The multilevel synthesis implementation is realized by optimizing area and delay in a circuit. However, optimizing multilevel synthesis logic is more difficult than optimizing two-level synthesis logic, and often employs heuristic techniques.

Functional synthesis is performed at the design entry stage to check that a design implements the specified architecture. Once Functional Verification is completed, the RTL is converted into an optimized gate level netlist, using smaller building blocks, in a step called Logic Synthesis or RTL synthesis. In EDA this task is performed by third party tools. The synthesis tool takes an RTL hardware description and a standard cell library for a particular manufacturer as input and produces a gate-level netlist as output. The standard cell library is the basic building block repository for today's IC design. Constraints for timing, area, speed, testability, and power are considered. Synthesis tools attempt to meet constraints by calculating the engineering cost of various implementations. The tool then attempts to generate the best gate level implementation for a given set of constraints, target the particular manufacturing process under consideration. The resulting gate-level netlist is a completely structural description with only standard cells at the “leaves” of the design. At logical/RTL synthesis it is also verified whether the Gate Level Conversion has been correctly performed by performing simulation. The netlist is typically modified to ensure any large net in the netlist has cells of proper drive strength (fan out), which indicates how many devices a gate can drive. A driving gate can be any cell in the standard cell library. During compilation of the netlist the EDA tool many adjust the size of the gate driving each net in the netlist so that area and power is not wasted in the circuit by having too large of a drive strength. Buffer cells are inserted when a large net is broken info smaller sections by the EDA tool.

Throughout the logical design state, an EDA tool performs a computer simulation of the layout before actual physical design.

The next step in the ASIC flow is the physical implementation of the gate level netlist, or physical design, such as system partitioning, floorplanning, placement and routing. The gate level netlist is converted into a geometric representation of the layout of the design. The layout is designed according to the design rules specified in the library for the fab that is to build the digital device. The design rules are guidelines based on the limitations of the fabrication process.

The physical implementation step consists of several sub steps: system partitioning, floorplanning, placement and routing. These steps relating to how the digital device is to be represented by the functional blocks, as one ASIC or several (system partitioning), how the functional blocks are to be laid out on one ASIC (floorplanning) and how the logic cells can be placed within the functional blocks (placement) and how these logic cells are to be interconnected with wiring (routing). The file produced at the output of this physical implementation is the so-called GDSII file, which is the file used by the foundry to fabricate the ASIC.

Floorplanning involves inputting into a floorplanning tool a netlist that describes the interconnection of ASIC blocks (RAM, ROM, ALU, cache controller, and the like); the logic cells (NAND, NOR, D flip-flop, and so on) within the blocks; and the logic cell connectors (e.g., terminals, pins, or ports). Floorplanning maps the logical description as found in the netlist to the physical description, the floorplan.

The goals of floorplanning are to arrange the ASIC blocks on the silicon chip, to decide the location of the I/O pads, to decide the location and number of the power pads, the type of power distribution, and the location and type of clock distribution. Design constraints in floorplanning include minimizing the silicon chip area and minimizing timing delay. Delay is often estimated from the total length of the interconnect and from an estimate of the total capacitance. Interconnect length and predicted interconnect capacitance is estimated from statistics of previously routed chips, including such factors as net fanout and block size of the circuits in the ASIC.

For any design to work at a specific speed, timing analysis has to be performed throughout the ASIC design flow. One must check using a Static Timing Tool in EDA whether the design is meeting the speed requirements of the specification. Industry standard Static Timing tools include Primetime (Synopsys), which verifies the timing performance of a design by checking the design for all possible timing violations caused by the physical design process.

During placement, for example, timing is effected since the length of an interconnect caused by placement changes the capacitance of the interconnect and hence changes the delay in the interconnect. The goal of an EDA placement tool is to arrange all the logic cells within the flexible blocks on a chip to achieve objectives such as: guarantee the router can complete the routing step, minimize all the critical net delays, make the chip as dense as possible, minimize power dissipation, and minimize cross talk between signals. Modern EDA placement tools use even more specific and achievable criteria than the above. The most commonly used placement objectives are one or more of the following: minimize the total estimated interconnect length, meet the timing requirements for critical nets, and minimize the interconnect congestion.

Algorithms for placement do exist, for example, the minimum rectilinear Steiner tree (MRST) is the shortest interconnect using a rectangular grid. The determination of the MRST is in general an NP-complete problem—which is difficult to solve in a reasonable time. For small numbers of terminals heuristic algorithms exist, but they are expensive in engineering cost to compute. Several approximations to the MRST exist and are used by EDA tools.

In the routing step, the wiring between the elements is planned. A Structured ASIC cross-section has metal layers; in a standard cell ASIC there may be say nine metal layers, but in many structured ASICs not all metal layers need be for routing, and some layers may be pre-routed, and only the top layers are used for routing. This reduces the complexity of the manufacturing process, since non-recurring engineering costs are much lower, as photolithographic masks are required only for the fewer metal layers not for every layer, and production cycles are much shorter, as metallization is a comparatively quick process. The metal layers may be interconnected with one another at select vertical holes called vias that are filled with metal or some conductor, called the ‘via’ layer, and thus be configurable at this interconnecting layer, or ‘via configurable’. If the logic fabric comprising the Structured ASIC is configured with traditional IC optical lithography involving photolithographic masks, it can be thought of as “mask programmable”. The mask for a Structured ASIC is programmed at the vias, which can be termed a via-configurable logic block (VCLB) architecture. The VCLB configuration and programmability may be performed by changing properties of so called “configurable vias”—connections between VCLB internal nodes. A configurable or programmable via may be in one of two possible states: it may be either enabled or disabled. If a programmable via is enabled, then it can conduct a signal (i.e., the via exists and has low resistance). If a via is disabled, then it cannot practically conduct a signal, i.e., the via has very high resistance or does not physically exist. In some designs, such as by the present assignee to this invention, eASIC Corporation, the customizable metallization layers may be reduced to a few or even a single via layer where the customization is performed, see by way of example and not limitation U.S. Pat. No. 6,953,956, issued to eASIC Corporation on Oct. 11, 2005; U.S. Pat. No. 6,476,493, issued to eASIC Corporation on Nov. 5, 2002; and U.S. Pat. No. 6,331,733, issued to eASIC Corporation on Dec. 18, 2001; all incorporated herein by reference in their entirety. Further, this single via layer could be customized without resorting to mask-based optical lithography, but with a maskless e-beam process, as taught by the '956 patent.

During circuit extraction and post layout simulation, a back-annotated netlist is used with timing information to see if the physical design has achieved the objectives of speed, power and the like specified for the design. If not, the entire ASIC design flow process is repeated. In modern EDA tools the delays calculated from a simulation library of library cells used in the design, during physical design steps, are placed in a special file called the SDF (Synopsys Delay Format) file. Each cell can have its own delay based on where in the netlist it is found, what are its neighboring cells, the load on the cell, the fan-in, and the like. Each internal path in a cell can have a different propagation time for a signal, known as a timing arc. The maximum possible clock rate is determined by the slowest logic path in the circuit, called the critical path.

Compounding the problem of delay is that in a synchronous ASIC one must avoid clock skew, and different parts of the ASIC may have different clock domains controlling them, with the wiring nets that establish the clock signal forming a clock net branching out in the form of a clock tree. Establishing this tree, which often requires additional circuitry like buffer cells to help drive the massive clock tree, is called clock tree synthesis. As an ASIC is a synchronous circuit, all the clocks in the clock tree must be in synch and chip timing control achieved, typically by using Phase-Locked Loops (PLLs) and/or Delay-Locked Loops (DLLs). If the clock signal arrives at different components at different times, there is clock skew. Clock skew can be caused by many different things, such as wire-interconnect length, temperature variations and differences in input capacitance on the clock inputs of devices using the clock. Further, timing must satisfy register setup and hold time requirements. Both data propagation delay and clock skew play important parts in these calculations. Problems of clock skew can be solved by reducing short data paths, adding delay in a data path, clock reversing and the like. Thus during the physical synthesis steps, clock synthesis is an important step, which distributes the clock network throughout the ASIC and minimizes the clock skew and delay.

Finally, IP in the form of proprietary third party functionality such as a semiconductor processor may be embedded in an ASIC using soft macros, firm macros and hard macros that can be bought from third parties. A soft macro describes the IP as RTL code and does not have timing closure given the design specification nor layout optimization for the process under consideration. However, as RTL code a soft macro can be modified by a designer with EDA tools and synthesized into the designer's library. By contrast, a hard macro is timing-guaranteed and layout-optimized for a particular design specification and process technology but is not portable outside the particular design and process under consideration, and is not represented in RTL code; rather a hard macro is tailored for a particular foundry and closer to GDSII layout. A firm macro falls between a hard macro and a soft macro. Firm macros are in netlist format, are optimized for performance/area/power using a specific fabrication technology, are more flexible and portable than hard macros, and more predictive of performance and area to be used than soft macros. Macros obviate a designer having to design every component from scratch, and are a great time saver. Third party designers favor firm and hard macros since it is easier to hide intellectual property (IP) present in such macros than it is to hide such IP in a soft macro.

Given the above, the pros and cons of standard cell ASICs versus a complex field programmable device such as an FPGA is as follows. The advantages of FPGAs are that they are easy to design, have shorter development times and thus are faster in time-to-market, and have lower NRE costs. These are also the disadvantages of standard cell ASICs: they are difficult to design, have long development times, and high NRE costs. The disadvantages of FPGAs are that design size is limited to relatively small production designs, design complexity is limited, performance is limited, power consumption is high, and there is a high cost per unit. These FPGA disadvantages are standard-cell advantages, as standard cells support large and complex designs, have high performance, low power consumption and low per-unit cost at a high volume.

A Structured ASIC falls between an FPGA and a Standard Cell-based ASIC in classification and performance. Structured ASIC's are used for mid-volume level designs. In a Structured ASIC the task for the designer is to map the circuit into a fixed arrangement of known cells.

Structured ASICs are closer to standard-cells in their advantages over FPGAs. The disadvantage of structured ASICs compared to FPGAs is that FPGAs do not require any user design information during manufacturing. Therefore, FPGA parts can be manufactured in larger volumes and can exist in larger inventories. This allows the latency of getting parts to customers in the right volumes to be reduced. FPGAs can also be modified after their initial configuration, which means that design bugs can be removed without requiring a fabrication cycle. Design improvements can be made in the field, and even done remotely, which removes the requirement of a technician to physically interact with the system.

Given these pros and cons, structured ASICs combine the best features of FPGAs and standard cell ASICS. Structured ASICs can have three main architectures: fine-grained, where the structured elements are unconnected discrete components, including transistors, resistors and other components; medium-grained, where the structured elements contain generic logic, such as gates, MUX's, LUT's or flip-flops; and, finally, hierarchical design, which contains mini-structured elements such as gates, MUX's and LUT's but no flip-flops for storage, with the flip-flops or registers added later. Hierarchical design has blocks and sub-blocks in a hierarchy, and takes more run time in an EDA tool than a flat design to build. The architectural comparison between fine-grained, medium-grained and hierarchical structured ASICs is that fine-grained structured ASICs require many connections in and out of a structured element, while the higher granularities reduce connections to the structured element but decreases the functionality they can support. Each individual design will benefit differently at these various granularities.

Structured ASIC advantages over standard cell ASICs and FPGAs include that they are largely prefabricated, with components are that are almost connected in a variety of predefined configurations and ready to be customized into any one of these configurations. Only a few metal layers are needed for fabrication of a Structured ASIC, which dramatically reduces the turnaround time. Structured ASICs are easier and faster to design than standard cell ASICs. Multiple global and local clocks are prefabricated in a Structured ASIC. Consequently, there are no skew problems that need to be addressed by the ASIC designer. Thus signal integrity and timing issues are inherently addressed, making design of a circuit simpler and faster. Capacity, performance, and power consumption in a Structured ASIC is closer to that of a standard cell ASIC. Further, structured ASICs have faster design time, reduced NRE costs, and quicker turnaround than standard cell ASICs. Thus with structured ASICs the per-unit cost is reasonable for several hundreds to 100 k unit production runs.

A technology comparison between standard cell ASICs, structured ASICs, and FPGAs, respectively, is roughly as follows: generally speaking, there is a ratio of 100:33:1 between the number of gates in a given area for standard cell ASIC's, structured ASICs, and FPGAs, respectively; a ratio of 100:75:15 for performance (based on clock frequency); and a ratio of 1:3:12 for power, though these ratios change year by year and at different process lithographic nodes.

Compared to a field-programmable gate array (FPGA), the unit price of a Structured ASIC solution may be reduced by a significant amount due to the removal of the storage and logic required for configuration storage and implementation. The unit cost of a Structured ASIC may be somewhat higher than a full custom ASIC, primarily due to the imperfect fit between design requirements and a standardized base layer, with certain I/O, memory and logic capacities.

Structured ASIC products may be differentiated by the point at which the user customization occurs and how that customization is actually implemented. Most structured ASICs may only standardize transistors and the lowest levels of metal. A large set of metal and via masks may be needed in order to customize a product. This yields a marginal cost reduction for NRE. Manufacturing latency and yield benefits may also be compromised using this approach.

An ideal ASIC device may combine the field programmability of FPGAs with the power and size efficiency of ASICs or structured ASICs.

A System-in-Package (SiP) are multiple bare dice and/or chip-scale package (CSP) devices, each implementing their own function (e.g., analog, digital, and radio frequency (RF) dice) that are mounted on a SiP common substrate, which is used to connect them together. The substrate and its components are then placed in (or built into) a single package, called an IC (Integrated Circuit) or SiP, which is a traditional two-dimensional (2D) chip. A 2.5D IC/SiP is different from a traditional 2D IC/SiP, and in one type of 2.5D IC a silicon interposer is placed between the SiP common substrate and the dice, where this silicon interposer has through-silicon vias connecting the metallization layers on the upper and lower surfaces of the silicon interposer. The multiple bare dice can be attached to the silicon interposer using micro-bumps, which are about ˜10 um in diameter. and in turn the silicon interposer is attached to the SiP substrate using regular flip-chip bumps, which can be ˜100 um in diameter. Further, a 3D IC/SiP configuration enable designers to achieve higher levels of integration by allowing multiple die to be stacked vertically on top of one another. Wire bonds connect a topmost die with an underlying SiP substrate and allow the topmost die to communicate with a SiP substrate that is covered by an underlying die.

A FET (Field Effect Transistor) is a transistor that uses an electric field to control the conductivity of a charge carrier channel in a semiconductor. A common type of FET is the Metal Oxide Semiconductor FET (MOSFET). MOSFET work by inducing a conducting channel between two contacts called the source and the drain by applying a voltage on the oxide-insulated gate electrode. Two types of MOSFET are called nMOSFET (commonly known as nMOS or NFET) and pMOSFET (commonly known as pMOS or PFET) depending on the type of carriers flowing through the channel. A nMOS transistor is made up of n-type source and drain and a p-type substrate. The three modes of operation in a nMOS are called the cut-off, triode and saturation. nMOS logic is easy to design and manufacture, but devices made of nMOS logic gates dissipate static power when the circuit is idling, since DC current flows through the logic gate when the output is low. By contrast, a pMOS transistor is made up of p-type source and drain and a n-type substrate. PMOS technology is low cost and has a good noise immunity. In a nMOS, carriers are electrons, while in a pMOS, carriers are holes; since electrons travel faster than holes, all things being equal NFETs are twice as fast as PFETs. When a high voltage is applied to the gate, with the gate-source voltage exceeding some threshold value (V_{GS}>V_{TH}), the nMOS will conduct, while pMOS will not; and conversely when a low voltage is applied in the gate, nMOS will not conduct and pMOS will conduct. PFETs are normally closed switches and NFETs are normally open switches. PFETs often occupy more silicon area than NFETs when forming logic blocks. PMOS devices are more immune to noise than nMOS devices. Furthermore, nMOS ICs are smaller than pMOS ICs with the same functionality, since the nMOS can provide one-half of the impedance provided by a pMOS under the same geometry and operating conditions.

Complementary metal-oxide-semiconductor (CMOS) is a technology for constructing integrated circuits. CMOS is sometimes referred to as complementary-symmetry metal-oxide-semiconductor (or COS-MOS). The words “complementary-symmetry” refer to the fact that the typical digital design style with CMOS uses complementary and symmetrical pairs of p-type and n-type metal oxide semiconductor field effect transistors (MOSFETs) for logic functions. Complementary Metal-Oxide-Silicon circuits require an nMOS and pMOS transistor technology on the same substrate. An n-type well is provided in the p-type substrate. Alternatively one can use a p-well or both an n-type and p-type well in a low-doped substrate. The gate oxide, poly-silicon gate and source-drain contact metal are typically shared between the pMOS and nMOS technology, while the source-drain implants are done separately. Since CMOS circuits contain pMOS devices, which are affected by the lower hole mobility, CMOS circuits are not faster than their all-nMOS counter parts. Even when scaling the size of the pMOS devices so that they provide the same current, the larger pMOS device has a higher capacitance.

The CMOS advantage is that the output of a CMOS inverter can be as high as the power supply voltage and as low as ground. This large voltage swing and the steep transition between logic levels yield large operation margins and therefore also a high circuit yield. In addition, there is no power dissipation in either logic state. Instead the power dissipation occurs only when a transition is made between logic states. CMOS circuits are therefore not faster than nMOS circuits but are more suited for very/ultra large-scale integration (VLSI/ULSI).

In electronics, a multiplexer (MUX or mux), sometimes called a data selector, is a circuit that selects one of several analog or digital input signals and forwards the selected input into a single line. A multiplexer of 2n inputs has n select lines, which are used to select which input line to send to the output. Demultiplexers take one data input and a number of selection inputs, and they have several outputs. Similarly, a decoder is a circuit that performs the reverse operations of an encoder.

In integrated circuits the need for temperature control for timing closure and for proper operation of the circuit is paramount. As CMOS process lithographic nodes shrink to 28 nm and smaller, the operating temperature of the chip becomes more important than ever. In so-called “corner cases” the timing closure of an ASIC configuration is tested at extremes of temperature to see if the timing closure is within the design specifications. It has been found that as lithographic nodes shrink, extreme cold temperatures become harder to achieve timing closure for a particular ASIC design than extreme heat.

The low and high operating temperature limits of a semiconductor device such as a Structured ASIC depends on a number of factors, including the properties of the basic semiconductor material (e.g. Si, GaAs), the type of device (bipolar transistor, diode, field-effect transistor), the materials, geometry and dimensions of the design, the design of the contacts and interconnections, the materials of the interconnections, the assembly and packaging materials and techniques, the nature of whether the chip is analog or digital, and other factors.

Thus, turning attention to the graph of FIG. 1 (not to scale), there is shown for a certain Structured ASIC configuration at 28 nm feature size or smaller, a graph of timing closure on the Y-axis, in some arbitrary number of units of time, versus temperature on the X-axis, in degrees Celsius, with X0 and X2 being extreme temperature ranges the Structured ASIC must be designed for, or temperature “corner cases”. As can be seen, at a temperature of X=X0=−65° C. timing closure for the particular Structured ASIC design is given by a time Y=Y0, while at a temperature of X=X2=125° C., timing closure is given by a time Y=Y2, where Y0>Y2. Meanwhile, the fastest timing closure for the Structured ASIC design under consideration is given at X=X1 where Y=Y1<Y2 and X0<X1<X2. Hence, contrary to some expectations, at extreme lower temperatures timing closure is hard to achieve than at extreme high temperatures for ASICs with small feature sizes of 28 nm and smaller.

Suppose further than timing closure is impossible for the particular Structured ASIC design under consideration, unless the design is changed, above a threshold=Y2, corresponding to a temperature of either X=X01=−55° C. (or greater) or X=X2=125° C. (or smaller). If the design specification calls for the ASIC to perform under a range of environmental operating temperatures from a range of −65° C. to 125° C., then either the chip design must be changed to allow the Structured ASIC to be able to achieve timing closure below a temperature of −55° C., or, the chip must be somehow prevented from going below the low temperature of −55° C. and yet still achieve timing closure when the environment in which the chip operates at is as cold as −65° C. The present invention addresses this problem.

What is lacking in the prior art is a temperature control block for use in a Structured ASIC that compensates for extreme low temperatures in corner cases to allow timing closure.

### SUMMARY OF THE INVENTION

Accordingly, an aspect of the present invention is to provide a temperature control for a Structured ASIC, manufactured using a CMOS process using NFET/nMOS and PFET/pMOS transistors, which includes a via-configurable logic block (VCLB) architecture. VCLB configuration may be performed by changing properties of so-called “configurable vias”—connections between VCLB internal nodes and elements in a Structured ASIC.

An aspect of the present invention is to provide a temperature control that is integral with the Structured ASIC, and resides on the chip.

An aspect of the present invention is to provide a temperature control for an IC die, with the temperature control having a small footprint.

As aspect of the present invention is to provide a temperature control that can be manufactured at the same time and with the same process that is used to manufacture the Structured ASIC in which it resides on.

Another aspect of the present invention is to provide a block on an IC semiconductor die for a Structured ASIC that provides active heating of the die.

Yet another aspect of the present invention is to provide for a temperature control that will allow a Structured ASIC to achieve timing closure for a range of environmental operating temperatures that without the temperature control the Structured ASIC could not achieve timing closure.

The sum total of all of the above advantages, as well as the numerous other advantages disclosed and inherent from the invention described herein, creates an improvement over prior techniques.

The above described and many other features and attendant advantages of the present invention will become apparent from a consideration of the following detailed description when considered in conjunction with the accompanying drawings.

### BRIEF DESCRIPTION OF THE DRAWINGS

Detailed description of preferred embodiments of the invention will be made with reference to the accompanying drawings. Disclosed herein is a detailed description of the best presently known mode of carrying out the invention. This description is not to be taken in a limiting sense, but is made merely for the purpose of illustrating the general principles of the invention. The section titles and overall organization of the present detailed description are for the purpose of convenience only and are not intended to limit the present invention.

FIG. 1 is a graph showing the relationship of timing closure versus temperature for 28 nm lithographic node Structured ASIC designs.

FIG. 2 (not to scale) is a block diagram showing the active heating temperature control of the present invention in a Structured ASIC.

It should be understood that one skilled in the art may, using the teachings of the present invention, vary embodiments shown in the drawings without departing from the spirit of the invention herein. In the figures, elements with like numbered reference numbers in different figures indicate the presence of previously defined identical elements.

### DETAILED DESCRIPTION OF THE INVENTION

The method and apparatus of the present invention may be described in software, such as the representation of the invention in an EDA tool, or realized in hardwire, such as the actual physical instantiation.

Regarding the floorplan of the present invention, the drawings sometimes show elements as blocks that in a physical implementation may differ from this stylized representation, but the essential features of the floorplan should be apparent to one of ordinary skill in the art from the teachings herein.

The elements in the floor plan of the present invention are operatively connected to one another where necessary, as can be appreciated by one of ordinary skill in the art from the teachings herein.

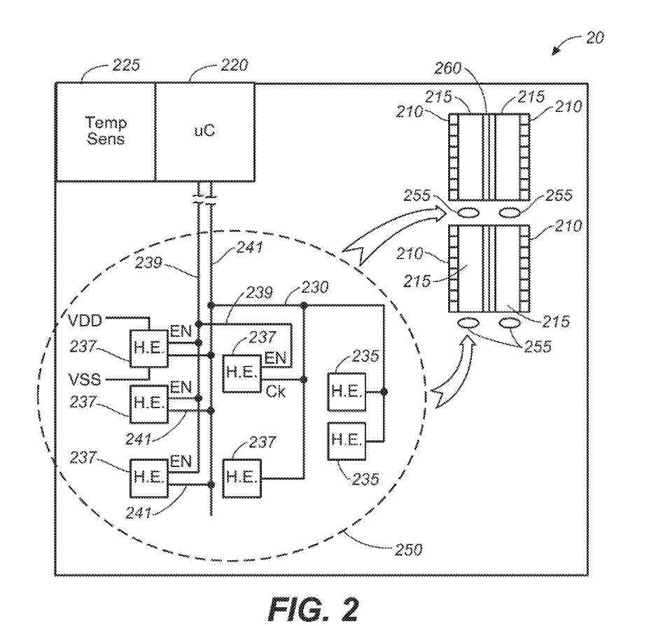

The temperature control device of the present invention, in particular as shown in the drawings, is for controlling the on-die temperature of a Structured ASIC. Turning attention to FIG. 2 (not to scale), there is shown a Structured ASIC 20 having a substantially rectilinear form. Logic 210 and memory 215 are present, along with a microcontroller or microprocessor block 220 designated as “uC” and a temperature sensor 225 designated as “Temp Sens”. The temperature sensor 225 can be any conventional temperature sensor for a semiconductor, e.g., a sensor such as a thermistor circuit or PN junction, that measures the temperature correlated properties of a signal diode or the gate-source junction of a transistor. The temperature sensor 225 measures the on-chip temperature of the Structured ASIC or die as much as possible, not the ambient temperature. The temperature sensor 225 may be located anywhere on the chip 20, not just at the corner as shown in FIG. 2.

On a chip die 20 a microcontroller block 220 is operatively connected to the temperature sensor block 225 and receives data relating to temperature from it, and acts as a control circuit to regulate temperature on the die. On the chip 20 there is a network which can be dedicated lines or a bus that are connected to active heating elements (designated “H.E.”), generically designated as blocks 235 for the sake of illustration (though in fact preferably these blocks 235 are decoupling cells 237, as explained further herein). The heating elements are dispersed throughout the chip 20 but preferably in gaps 255 between columns of memory 215, as shown and as explained further herein. Thus a plurality of elements designated as grouping 250, with dashed lines surrounding the plurality of elements, would be placed inside a plurality of gaps 255 that lie between vertically aligned portions of logic 210 and memory 215 arrayed in columnar form in the chip 20, as shown conceptually in FIG. 2 by the hollow arrows pointing to the ovals representing gaps 255. Each of these groupings 250 would be operatively connected with enable and clock lines 239, 241 to a microcontroller 220 as further explained herein.

In a preferred embodiment the heating elements are decoupling cell blocks 237 (which is a specific embodiment of the generic block 235, so that active heating element blocks 235 are the generic equivalents of the decoupling cell blocks 237 in FIG. 2). The decoupling cell blocks 237 have a enable line 239 for controlling state and a clock signal line 241. However the heating elements may be capacitors, or may be any other active heating element that produces heat, including resistors, that can be operatively turned on and off by the microcontroller 220.

The decoupling cells are connected to the network by two signal lines, one being enable line “EN” (line 239) and the other being clock (line 241). When the enable line is OFF or zero at every clock cycle the decoupling cell block 237 is building capacitance and will build up charge. When the enable line is ON or 1 at every clock cycle the decoupling cell block 237 will dissipate charge and generate or dissipate heat. By switching from Enable=ON to Enable=OFF, together with the clock the decoupling cells will build up charge and discharge charge, generating heat, which is termed dynamic power dissipation.

The heating elements 237 comprising decoupling cells such as shown collectively by the collection 250 of heating element blocks 235 or 237 are preferably placed in a BRAM memory cell column 215 at gaps or breaks in the column such as gaps 255 in-between BRAM memory cell 215 columns, with having a clock bus 260 running down the center of the BRAM columns.

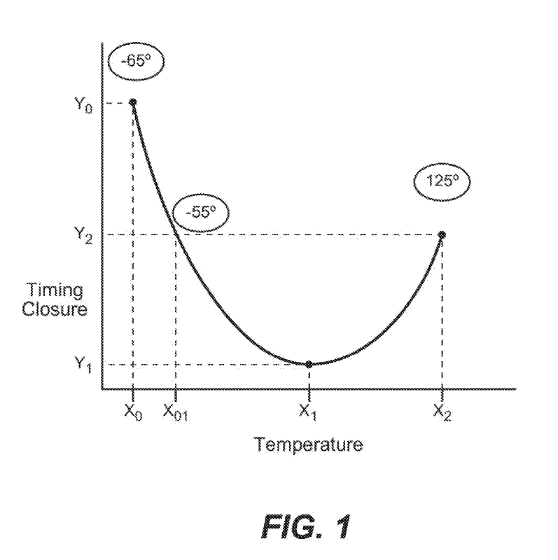

Operation of the temperature controlling aspect of the chip 100 is as follows, assuming that the chip is operating in an ambient cold temperature environment. When the microcontroller 220 senses from temperature sensor 225 that the on-die temperature is below a certain predetermined minimum temperature such as temperature T=X=X01 as shown in FIG. 1 where it is determined timing closure will fail, due to the fact that ambient outside temperature is below this temperature, the microcontroller 220 will instruct the active heating elements 235 (or more specifically the decoupling cell 237, in the case a decoupling cell block is used) to begin switching to dissipate heat, such as in a preferred embodiment by instructing the decoupling cell blocks 237 to switch on and off as described herein, by toggling the state of the decoupling cell blocks from ON to OFF. At this point the on-die temperature of the chip 20 will begin to increase from T=X01 to a higher temperature. At some point the chip temperature will exceed some predetermined temperature T=TMAX beyond which it is not necessary to heat the chip die with the active heating elements 235 (or 237), and the microcontroller will turn off the active heating elements, such as in the preferred embodiment by switching off the decoupling cell blocks 237 by keeping their state off as by setting their Enable input to 0 (OFF). Then, as die temperature begins to drop, the temperature of the die will again fall below the minimum temperature threshold of T=X01, below which the chip cannot achieve timing closure, and this will be sensed by the temperature sensor 225, which is being sampled by the microcontroller 220. The microcontroller 220 will then repeat the cycle by turning on the active heating elements 235 (or in a preferred embodiment such as the decoupling cell blocks 237), the heating elements switched on and off by the microcontroller, and the die will again begin to heat up. A suitable factor of safety of some increment in temperature can be provided to the minimum temperature at which the heating elements are switched on by the microcontroller, so that the microcontroller switches on these heating elements at some greater temperature equal to the minimum temperature plus the factor of safety incremental temperature, so that the minimum temperature is never reached on the die in practice. This cycling of the heating elements under the control of the microcontroller with the on/off switching of heating elements determined from the feedback of temperature can be termed dynamic power dissipation with feedback.

Silicon in the CMOS process used to construct the present invention will dissipate any heat created by the heating elements 235 or 237. The microcontroller 220 may also turn on and off the heating elements in a gradual manner so that heat does not spike up to quickly. In lieu of a microcontroller 220 a dedicated circuit may be used or a dedicated microcontroller may be employed.

Regarding manufacture of the present semiconductor via-configurable Structured ASIC, it may be manufactured on a 28 nm CMOS process lithographic node or smaller and having feature sizes of this dimension or smaller. The method of manufacturing the ASIC may be as the flow was described herein in connection with an ASIC and/or Structured ASIC; and the temperature controlled portion of the Structured ASIC would be the block of logic as described herein. The Structured ASIC of the present invention are manufactured using a CMOS semiconductor process using NFET/nMOS and PFET/pMOS transistors, which includes a via-configurable logic block (VCLB) architecture. VCLB configuration may be performed by changing properties of so called “configurable vias”—connections between VCLB internal nodes. The configurable vias that are used to customize the chip at a plurality of metal layers, and preferably between two metal layers with a single via layer, and are changed by the customer that deploys the Structured ASIC. A traditional 2D chip layout may be used or a 2.5D layout may be deployed.

Modifications, subtractions and/or additions can be applied by one of ordinary skill from the teachings herein without departing from the scope of the present invention. Thus the scope of the invention is limited solely by the claims.

It is intended that the scope of the present invention extends to all such modifications and/or additions and that the scope of the present invention is limited solely by the claims set forth below.

We claim:

1. A semiconductor die, comprising:
a temperature sensor for measuring temperature of the semiconductor die;
a control circuit for receiving data from said temperature sensor;
an active heating element under the control of the control circuit for heating said semiconductor die when temperature drops below a predetermined value on said die.

2. The device according to claim 1, wherein:
said control circuit is a microcontroller.

3. The device according to claim 2, wherein:
said active heating elements are controlled by said microcontroller to switch on and off through feedback of temperature.

4. The device according to claim 3, further comprising:
said active heating element comprises a plurality of decoupling cell blocks on said semiconductor die.

5. The device according to claim 4, wherein:
each said decoupling cell block has a clock signal input line and an enable signal input line.

6. The device according to claim 5, wherein:
each said decoupling cell block will accumulate capacitance charge when said enable signal input is off at every clock cycle and dissipate capacitance charge when said enable signal input is on at every clock cycle;
said microcontroller operates to turn on each decoupling cell block to heat the die when the temperature falls below a predetermined minimum temperature and operates to turn off each decoupling cell block when the temperature rises above a predetermined maximum temperature.

7. The device according to claim 4, further comprising:
memory and logic disposed on said semiconductor die, said memory and logic disposed in columns on said die, said columns having gaps; and,
said active heating elements disposed on gaps in said columns.

8. The device according to claim 7, wherein:
said decoupling cell block generates heat by periodically cycling between accumulating charge and discharging charge depending on whether the clock signal on said clock signal input line and the ON/OFF state of said enable signal input line.

9. The device according to claim 8, wherein:
said microcontroller operates to turn on each decoupling cell block to heat the die when the temperature falls below a predetermined minimum temperature and operates to turn off the decoupling cell block when the temperature rises above a predetermined maximum temperature.

10. The device according to claim 9, wherein:
said temperature sensor is a temperature sensor selected from the group consisting of a thermistor circuit, a sensor measuring the temperature correlated properties of a PN junction, a sensor measuring the temperature correlated properties a signal diode or a sensor measuring the temperature correlated properties of a gate-source junction of a transistor.

11. The device according to claim 3, wherein:
said temperature sensor is a temperature sensor selected from the group consisting of a thermistor circuit, a sensor measuring the temperature correlated properties of a PN junction, a sensor measuring the temperature correlated properties a signal diode or a sensor measuring the temperature correlated properties of a gate-source junction of a transistor.

12. The device according to claim 3, wherein:
said active heating element is a resistor;
memory and logic disposed on said semiconductor die in columns;
said active heating elements disposed on gaps in said columns; and,
said temperature sensor is a temperature sensor selected from the group consisting of a thermistor circuit, a sensor measuring the temperature correlated properties of a PN junction, a sensor measuring the temperature correlated properties a signal diode or a sensor measuring the temperature correlated properties of a gate-source junction of a transistor.

13. A method for controlling the temperature of an semiconductor die for an IC, comprising the steps of:
measuring the temperature of the semiconductor die using a temperature sensor on said semiconductor die;
receiving temperature data from said temperature sensor with a control circuit;
controlling at least one active heating element with said control circuit in response to said temperature data received; and,
heating said die with said active heating element under the control of the control circuit when the temperature drops below a predetermined minimum value on said die.

14. The method according to claim 13, further comprising the steps of:
receiving said temperature data from said temperature sensor with said control circuit comprising a microcontroller.

15. The method according to claim 14, further comprising the steps of:
turning on said active heating element under the control of said microcontroller when temperature drops below said predetermined value on said die as measured by said temperature sensor;
turning off said active heating element under the control of said microcontroller when temperature rises above a second predetermined maximum value as measured by said temperature sensor.

16. The method according to claim 15, wherein:
said active heating element comprises a plurality of decoupling cell blocks on said semiconductor die, operatively connected to said microcontroller.

17. The method according to claim 15, further comprising the steps of:
placing memory and logic on said die in columns, said columns having gaps; and, placing said decoupling cell blocks in said gaps in said columns.

18. The method according to claim 16, further comprising the steps of:
cycling said decoupling cell block to generate heat by turning on and off said decoupling cell block using a clock signal line and an enable signal line.

19. The method according to claim 18, further comprising the steps of:
charging said decoupling cell block to accumulate charge by when said enable signal input is OFF at every clock cycle and discharging said decoupling cell block to dissipate charge when said enable signal input is ON at every clock cycle.

20. The method according to claim 13, further comprising the steps of:
placing memory and logic disposed on said semiconductor die in columns, said columns having gaps;
wherein said active heating element is a resistor; said active heating elements disposed on gaps in said columns;
providing said temperature sensor from a temperature sensor selected from the group consisting of a thermistor circuit, a sensor measuring the temperature correlated properties of a PN junction, a sensor measuring the temperature correlated properties a signal diode or a sensor measuring the temperature correlated properties of a gate-source junction of a transistor; and,
turning on said resistor under the control of said microcontroller when temperature drops below said predetermined value on said die as measured by said temperature sensor;
turning off said resistor under the control of said microcontroller when temperature rises above a second predetermined maximum value as measured by said temperature sensor.
